(19) United States
(12) Patent Application Publication
(10) Pub. No.: US 2023/0304843 A1
(43) Pub. Date: Sep. 28, 2023

(54) TRANSDUCER FOR A VIBRATING FLUID METER

(71) Applicant: MICRO MOTION, INC., Boulder, CO (US)

(72) Inventors: Mark LUPIENSKI, Superior, CO (US); Jeffrey NIELSON, Longmont, CO (US)

(73) Assignee: MICRO MOTION, INC., Boulder, CO (US)

(21) Appl. No.: 18/018,651

(22) PCT Filed: Apr. 2, 2021
(86) PCT No.: PCT/US2021/025562

§ 371 Date: Jan. 30, 2023

Related U.S. Application Data
(60) Provisional application No. 63/061,903, filed on Aug. 6, 2020.

(51) Int. Cl. G01F 1/84

(52) U.S. Cl. CPC G01F 1/8422

(57) ABSTRACT

A transducer assembly (300) for a vibrating meter having meter electronics (20) is provided. The transducer assembly (300) comprises a keeper portion (401) comprising a keeper plate (402). A magnet portion (301) comprises a coil bobbin (305) and a coil (309) wound around the coil bobbin (305). A magnet (313) is coupled to the coil bobbin (305). The keeper plate (402) is prevented from contacting the coil bobbin (305).

### TECHNICAL FIELD

The embodiments described below relate to, vibrating meters, and more particularly, to a transducer for a vibrating fluid meter.

### BACKGROUND OF THE INVENTION

Vibrating meters, such as for example, vibrating densitometers and Coriolis flow meters are generally known and are used to measure mass flow and other information for materials within a conduit. The material may be flowing or stationary. Exemplary Coriolis flow meters are disclosed in U.S. Pat. Nos. 4,109,524, 4,491,025, and Re. 31,450 all to J. E. Smith et al. These flow meters have one or more conduits of straight or curved configuration. Each conduit configuration in a Coriolis mass flow meter has a set of natural vibration modes, which may be of simple bending, torsional, or coupled type. Each conduit can be driven to oscillate at a preferred mode.

Material flows into the flow meter from a connected pipeline on the inlet side of the flow meter, is directed through the conduit(s), and exits the flow meter through the outlet side of the flow meter. The natural vibration modes of the vibrating, material filled system are defined in part by the combined mass of the conduits and the material flowing within the conduits.

When there is no flow through the flow meter, a driving force applied to the conduit(s) causes all points along the conduit(s) to oscillate with identical phase or a small “zero offset”, which is a time delay measured at zero flow. As material begins to flow through the flow meter, Coriolis forces cause each point along the conduit(s) to have a different phase. For example, the phase at the inlet end of the flow meter lags the phase at the centralized driver position, while the phase at the outlet leads the phase at the centralized driver position. Pick-off sensors on the conduit(s) produce sinusoidal signals representative of the motion of the conduit(s). Signals output from the pick-off sensors are processed to determine the time delay between the pick-off sensors. The time delay between the two or more pick-off sensors is proportional to the mass flow rate of material flowing through the conduit(s).

Meter electronics connected to the driver generates a drive signal to operate the driver and determines a mass flow rate and other properties of a material from signals received from the pick-off sensors. The driver may comprise one of many well-known arrangements; however, a magnet and an opposing drive coil have received great success in the vibrating meter industry. Examples of suitable drive coil and magnet arrangements are provided in U.S. Pat. No. 7,287,438 as well as U.S. Pat. No. 7,628,083, which are both assigned on their face to Micro Motion, Inc. and are hereby incorporated by reference. An alternating current is passed to the drive coil for vibrating the conduit(s) at a desired flow tube amplitude and frequency. It is also known in the art to provide the pick-off sensors as a magnet and coil arrangement very similar to the driver arrangement. However, while the driver receives a current, which induces a motion, the pick-off sensors can use the motion provided by the driver to induce a voltage. The voltage is proportional to conduit displacement. The magnitude of the time delay measured by the pick-off sensors is very small; often measured in nanoseconds. Therefore, it is necessary to have the transducer output be very accurate.

FIG. 1 illustrates an example of a prior art vibrating meter 5 in the form of a Coriolis flow meter comprising a sensor assembly 10 and a meter electronics 20. The meter electronics 20 is in electrical communication with the sensor assembly 10 to measure characteristics of a flowing material, such as, for example, density, mass flow rate, volume flow rate, totalized mass flow, temperature, and other information.

The sensor assembly 10 includes a pair of flanges 101 and 101′, manifolds 102 and 102′, and conduits 103A and 103B. Manifolds 102, 102′ are affixed to opposing ends of the conduits 103A, 103B. Flanges 101 and 101′ of the prior art Coriolis flow meter are affixed to opposite ends of the spacer 106. The spacer 106 maintains the spacing between manifolds 102, 102′ to prevent undesired vibrations in the conduits 103A and 103B. The conduits 103A and 103B extend outwardly from the manifolds in an essentially parallel fashion. When the sensor assembly 10 is inserted into a pipeline system (not shown) which carries the flowing material, the material enters sensor assembly 10 through flange 101, passes through the inlet manifold 102 where the total amount of material is directed to enter conduits 103A and 103B, flows through the conduits 103A and 103B and back into the outlet manifold 102′ where it exits the sensor assembly 10 through the flange 101′.

The prior art sensor assembly 10 includes a driver 104. The driver 104 is affixed to conduits 103A and 103B in a position where the driver 104 can vibrate the conduits 103A, 103B in the drive mode, for example. More particularly, the driver 104 includes a first driver component 104A affixed to the conduit 103A and a second driver component 104B affixed to the conduit 103B. The driver 104 may comprise one of many well-known arrangements such as a coil mounted to the conduit 103A and an opposing magnet mounted to the conduit 103B.

In the present example of the prior art Coriolis flow meter, the drive mode is the first out of phase bending mode and the conduits 103A, 103B are selected and appropriately mounted to inlet manifold 102 and outlet manifold 102′ so as to provide a balanced system having substantially the same mass distribution, moments of inertia, and elastic moduli about bending axes W-W and W′-W′, respectively. In the present example, where the drive mode is the first out of phase bending mode, the conduits 103A and 103B are driven by the driver 104 in opposite directions about their respective bending axes W-W and W′-W′. A drive signal in the form of an alternating current can be provided by the meter electronics 20, such as for example via pathway 110, and passed through the coil to cause both conduits 103A, 103B to oscillate. Those of ordinary skill in the art will appreciate that other drive modes may be used by the prior art Coriolis flow meter.

The sensor assembly 10 shown includes a pair of pick-offs 105, 105′ that are affixed to the conduits 103A, 103B. More particularly, first pick-off components 105A and 105′A are located on the first conduit 103A and second pick-off components 105B and 105′B are located on the second conduit 103B. In the example depicted, the pick-offs 105, 105′ may be electromagnetic detectors, for example, pick-off magnets and pick-off coils that produce pick-off signals that represent the velocity and position of the conduits 103A, 103B. For example, the pick-offs 105, 105′ may supply pick-off signals to the meter electronics 20 via pathways 111, 111′. Those of ordinary skill in the art will appreciate that the motion of the conduits 103A, 103B is generally proportional to certain characteristics of the flowing material, for example, the mass flow rate and the density of the material flowing through the conduits 103A, 103B. However, the motion of the conduits 103A, 103B also includes a zero-flow delay or offset that can be measured at the pick-offs 105, 105′. The zero-flow offset can be caused by a number of factors such as non-proportional damping, residual flexibility response, electromagnetic crosstalk, or phase delay in instrumentation.

The prior art sensor assemblies 103, 104, and 105 are aligned on the axis of the coil to minimize air gap in the magnetic circuit and maximize the coupling between the magnet and coil fields. Generally, the keeper assembly is mounted to a first conduit, while the coil assembly is mounted to a second conduit (the arrangement is different for single conduit meters). The keeper and coil must be carefully mounted to maximize clearance between the components.

Unfortunately, coil and keeper assemblies can make contact under certain conditions, with the result being a damaged and likely non-functional flowmeter. For example, manufacturing variation may result in axial misalignment. In another circumstance, a slug of fluid that travels through one conduit to a greater extent than the mating conduit can cause inertial forces and relative lateral motion between the tubes such that magnet/coil/keeper contact occurs and damage to the assembly is the result. In yet another example, temperature differentials may result in coil and keeper assembly contact. Hot fluid flowing through one conduit at a time point significantly earlier than flowing through the mating conduit may result in uneven conduit expansion to the extent that the coil/keeper clearance limits are exceeded, and contact is made.

Therefore, as can be appreciated, the traditional transducer assembly may, under a number of circumstances potentially encountered during normal meter operation, be prone to suffering damage due to misalignment. There exists a need in the art for a transducer assembly sensor that is immune from misalignment and the resultant damage. The embodiments described below overcome these and other problems and an advance in the art is achieved.

### SUMMARY OF THE INVENTION

A transducer assembly for a vibrating meter having meter electronics is provided. The transducer assembly comprises a keeper portion comprising a keeper plate. The transducer assembly comprises a magnet portion comprising a coil bobbin, a coil wound around the coil bobbin, a magnet coupled to the coil bobbin, and wherein the keeper plate is prevented from contacting the coil bobbin.

A method for forming a vibrating meter including a sensor assembly with one or more flow conduits is provided. The method comprises the steps of forming a keeper portion comprising a keeper plate and coupling the keeper portion to a first component of the vibrating meter. A magnet portion is formed comprising a coil bobbin, and the magnet portion is coupled to a second component of the vibrating meter. A coil is wound around the coil bobbin. A magnet is coupled to the coil bobbin. The keeper plate is placed proximate the magnet, and the coil is electrically coupled to a meter electronics.

### ASPECTS

According to an aspect, a transducer assembly for a vibrating meter having meter electronics comprises a keeper portion comprising a keeper plate. The transducer assembly comprises a magnet portion comprising a coil bobbin, a coil wound around the coil bobbin, a magnet coupled to the coil bobbin, and wherein the keeper plate is prevented from contacting the coil bobbin.

Preferably, a flux ring disposed to circumscribe at least a portion of the coil bobbin.

Preferably, a flux ring disposed to circumscribe at least a portion of the coil.

Preferably, the magnet is coupled to the coil bobbin with a pole piece.

Preferably, the magnet is a permanent magnet.

Preferably, the coil bobbin, the coil, and the magnet are fixed in place with relation to each other.

Preferably, the meter electronics provides an oscillating current to the coil that induces motion of the keeper plate.

Preferably, the keeper portion and the magnet portion are coupled to first and second portions of the vibrating meter, respectively, wherein at least one of the first and second portions of the vibrating meter comprise a flow conduit.

According to an aspect, a method for forming a vibrating meter including a sensor assembly with one or more flow conduits comprises the steps of forming a keeper portion comprising a keeper plate and coupling the keeper portion to a first component of the vibrating meter. A magnet portion is formed comprising a coil bobbin, and the magnet portion is coupled to a second component of the vibrating meter. A coil is wound around the coil bobbin. A magnet is coupled to the coil bobbin. The keeper plate is placed proximate the magnet, and the coil is electrically coupled to a meter electronics.

Preferably, the first component and second component comprise at least one flow conduit.

Preferably, the method comprises the step of circumscribe at least a portion of the coil bobbin with a flux ring.

Preferably, the method comprises the step of coupling the magnet to the coil with a pole piece.

Preferably, the method comprises the step of fixing the coil bobbin, coil, and magnet in place with relation to each other.

Preferably, the method comprises the step of providing an oscillating current to the coil that induces motion of the keeper plate.

Preferably, the method comprises the step of receiving an oscillating current from the coil, wherein the oscillating current is induced by the motion of the keeper plate.

### BRIEF DESCRIPTION OF THE DRAWINGS

FIG. 1 shows a prior art fluid meter.

FIG. 2 shows a cross-sectional view of a prior art transducer assembly.

FIG. 3 shows a magnet portion of a transducer assembly according to an embodiment.

FIG. 4 shows a keeper portion of a transducer assembly according to an embodiment.

FIG. 5 shows a cross-sectional view of a transducer assembly according to an embodiment.

### DETAILED DESCRIPTION OF THE INVENTION

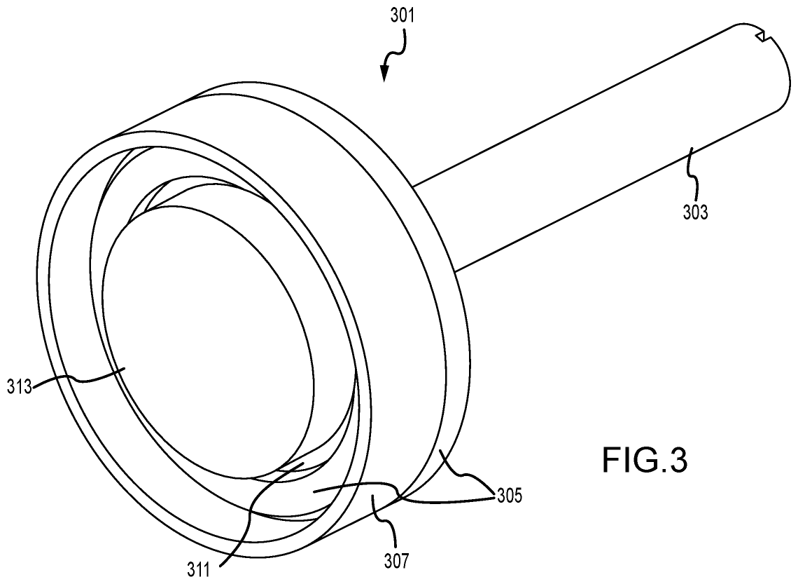

FIGS. 3-5 and the following description depict specific examples to teach those skilled in the art how to make and use the best mode of embodiments of a transducer. For the purpose of teaching inventive principles, some conventional aspects have been simplified or omitted. Those skilled in the art will appreciate variations from these examples that fall within the scope of the present description. Those skilled in the art will appreciate that the features described below can be combined in various ways to form multiple variations of the fluid meter. As a result, the embodiments described below are not limited to the specific examples described below, but only by the claims and their equivalents.

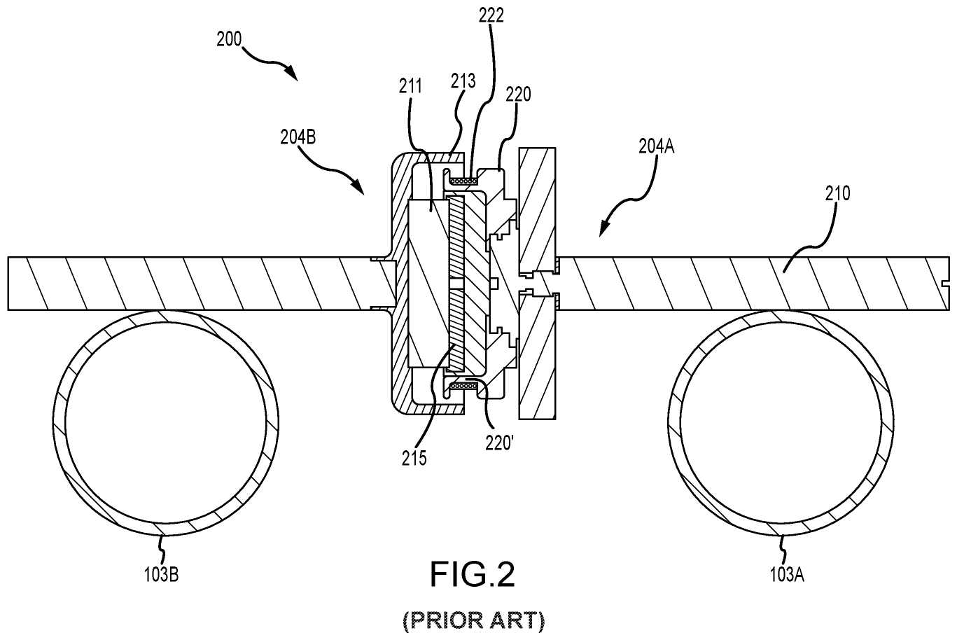

FIG. 2 shows a cross-sectional view of a prior art transducer assembly 200. The transducer assembly 200 can be coupled to the first and second flow conduits 103A, 103B. The prior art transducer assembly 200 comprises a coil portion 204A and a magnet portion 204B. The magnet portion 204B comprises a magnet 211. The magnet 211 can be positioned within a magnet keeper 213 that can help direct the magnetic field. The magnet portion 204B may also comprise a pole piece 215. The magnet portion 204B comprises a typical magnet portion of prior art sensor components. The magnet portion 204B may be coupled to the second flow conduit 103B with a mounting bracket (not shown for clarity). The mounting bracket may be coupled to the flow conduit 103B according to well-known techniques such as welding, brazing, bonding, etc.

The coil portion 204A may be coupled to the first flow conduit 103A with a mounting bracket (not shown for clarity). The mounting bracket may be coupled to the flow conduit 103A according to well-known techniques such as welding, brazing, bonding, etc.

The coil portion 204A also comprises a coil bobbin 220. The coil bobbin 220 can include a magnet receiving portion 220′ for receiving at least a portion of the magnet 211. The coil bobbin 220 comprises a coil 222. The coil bobbin 220 can be held onto the mounting bracket 210 with a fastening device.

FIG. 3 shows a magnet portion 301 of a transducer assembly 300 (shown in FIG. as a cross section) according to an embodiment. A bracket 303 is attached to the coil bobbin 305. The bracket 303 may be coupled to the coil bobbin 305 with a mechanical fastener, adhesive, by welding/brazing, or by other methods known in the art. The particular method used to couple the coil bobbin 305 to the bracket 303 should in no way limit the scope of the present embodiment. In an embodiment, the bracket 303 and coil bobbin 305 are formed from the same piece of material. The forming of the bracket 303 and coil bobbin 305 may be through machining operations, casting/molding operations, 3D printing or similar additive manufacturing methods.

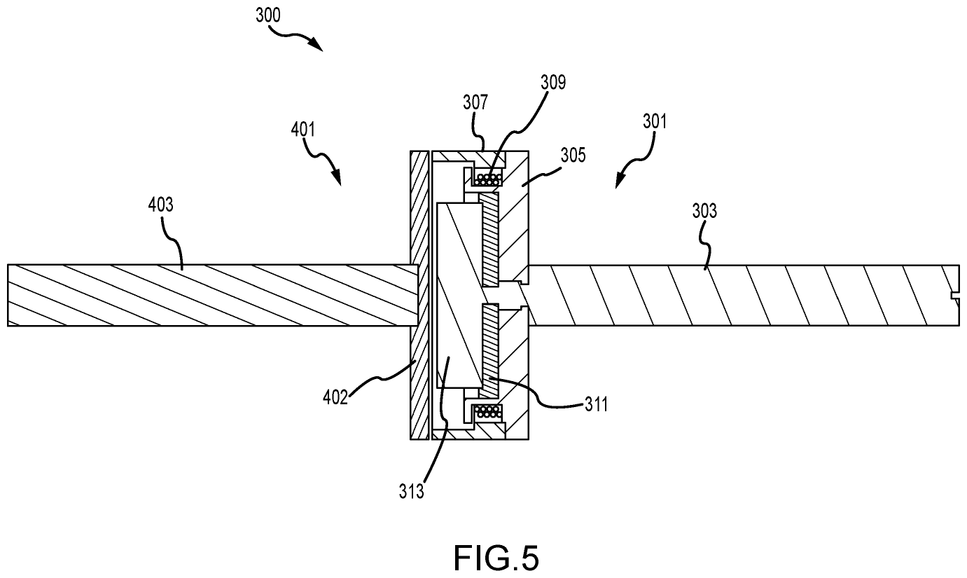

The coil bobbin 305 may be plastic, ceramic, polymeric, or otherwise non-magnetic. In an embodiment, the coil bobbin 305 may be made from ferrous materials. A flux ring 307 may circumscribe a portion of the coil bobbin 305. The flux ring 307 may also circumscribe a portion or all of a coil 309 (see FIG. 5) wound around the coil bobbin 305. The flux ring 307 may be formed from carbon steel or another mu metal, and aids in isolating the electric fields associated with the individual wires in the system. A pole piece 311 is coupled to the inner diameter of the coil bobbin 305 and moves with the coil bobbin 305, thus forming part of a magnetic circuit. A magnet 313 is coupled to the pole piece 311, and moves with the pole piece/bobbin 311, 305 to form part of the magnetic circuit.

The axial position of the pole is optimized to maximize coil to pole coupling, and the bobbin hub thickness is minimized to maximize coil to pole coupling. The precise dimensions to achieve these optimizations differ depending on the size of the assembly, the size of the bobbin, the number of coil windings, the strength of the magnet, the throw of the transducer, etc., as will be understood by those skilled in the art.

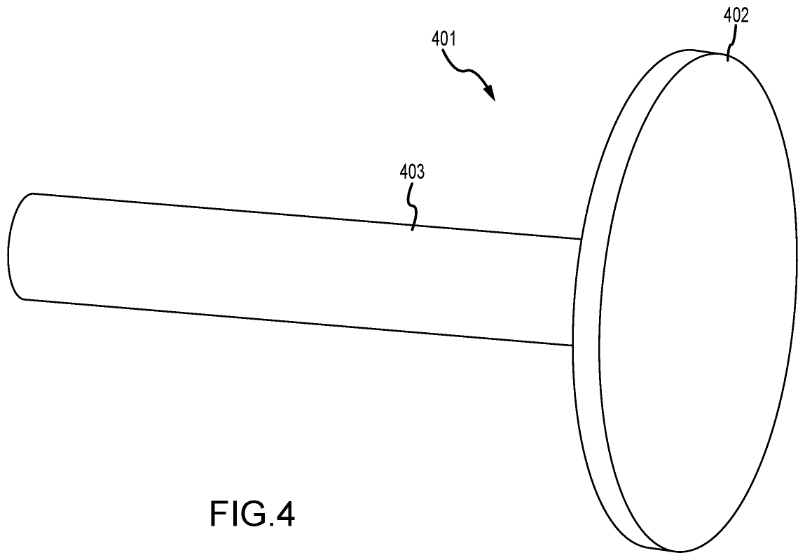

FIGS. 4 and 5 shows a keeper portion 401 of the transducer assembly 300 (shown in FIG. 5). A keeper plate 402 is coupled to a bracket 403. The bracket 403 may be coupled to the keeper plate 402 with a mechanical fastener, adhesive, by welding/brazing, or by other methods known in the art. The particular method used to couple the keeper plate 402 to the bracket 403 should in no way limit the scope of the present embodiment.

It will thus be appreciated that this is a large departure from prior art transducers, as virtually all components of the proposed transducer assembly 300 are arranged on a single side/bracket. That is to say that the magnet 313 and pole piece 311 that magnetically interact with the coil/coil bobbin 309, 305 are not only situated on the same bracket 303 but are fixed in place with relation to each other.

In an embodiment the magnet 313 is a permanent magnet, though an electromagnet is contemplated. The magnet in the proposed invention will create a magnetic circuit through the adjacent components and attract the keeper plate 402. An oscillating current through the coil 309 will increase/decrease the force on the keeper plate 402 causing it to oscillate. The transducer assembly 300 is constructed such that it may be used as both a driver and a pickoff sensor. The transducer circuits will operate in the same way mechanically as the prior art but output a voltage proportional to the magnet/keeper plate gap. The invention will thus behave like existing drive and pickoff circuits but eliminate the above-noted problems related to coil/keeper positioning issues and misalignment and sources of lateral movement.

The transducer assembly 300 is generally coupled to a dual flow conduit sensor assembly, in other embodiments, one of the portions 303, 403 may be coupled to a stationary component or a dummy tube, or balance bar, or case component, for example. This may be the case in situations where the combined transducer assembly 300 is utilized in a single flow conduit sensor assembly.

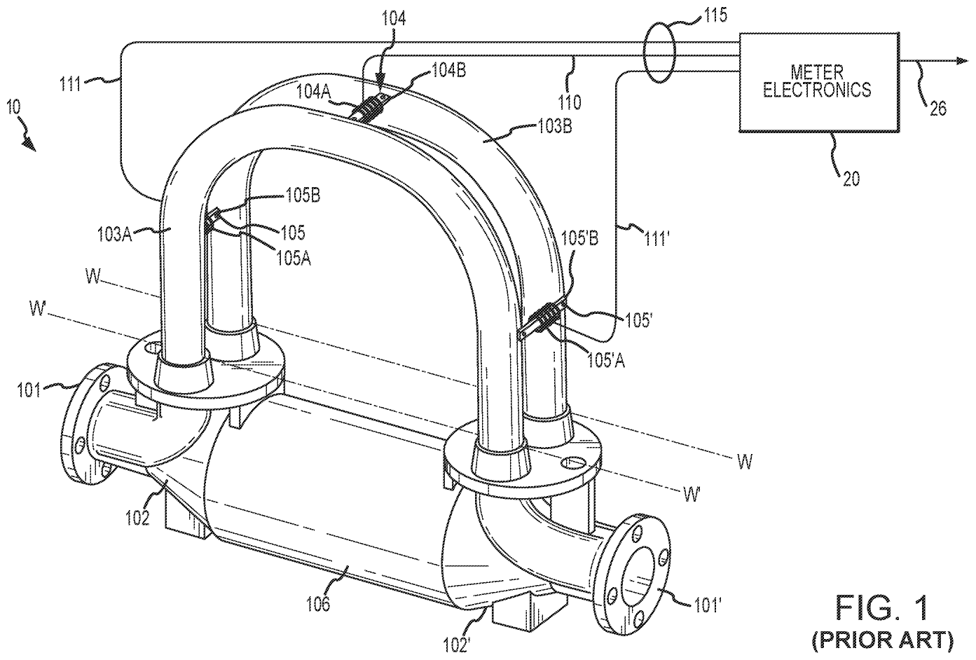

Although not shown for clarity, it should be appreciated that meter electronics 20 can communicate with a wire lead similar to the wire 110 shown in FIG. 1. Therefore, when in electrical communication with the meter electronics 20, the transducer assembly 300 can be provided with a drive signal in order to create motion between the magnet portion 301 and the keeper portion 401. Likewise, the transducer assembly 300 can communicate with the meter electronics 20 with a wire lead similar to one of the wire leads 111, 111′ shown in FIG. 1. Therefore, when in electrical communication with the meter electronics, the transducer assembly 300 can sense motion between the magnet portion 301 and the keeper portion 401.

A vibrating meter, such as that shown in FIG. 1 may comprise the transducer assembly 300. The vibrating meter may comprise a Coriolis flow meter or some other vibratory meter. The vibrating meter can receive a fluid that may be flowing or stationary. The fluid may comprise a gas, a liquid, a gas with suspended particulates, a liquid with suspended particulates, a multiphase fluid, or a combination thereof.

The detailed descriptions of the above embodiments are not exhaustive descriptions of all embodiments contemplated by the inventors to be within the scope of the present description. Indeed, persons skilled in the art will recognize that certain elements of the above-described embodiments may variously be combined or eliminated to create further embodiments, and such further embodiments fall within the scope and teachings of the present description. It will also be apparent to those of ordinary skill in the art that the above-described embodiments may be combined in whole or in part to create additional embodiments within the scope and teachings of the present description.

Thus, although specific embodiments are described herein for illustrative purposes, various equivalent modifications are possible within the scope of the present description, as those skilled in the relevant art will recognize. The teachings provided herein can be applied to other fluid meters, and not just to the embodiments described above and shown in the accompanying figures. Accordingly, the scope of the embodiments should be determined from the following claims.

We claim:

1. A transducer assembly (300) for a vibrating meter having meter electronics (20), comprising:
a keeper portion (401) comprising a keeper plate (402);
a magnet portion (301) comprising:
a coil bobbin (305);
a coil (309) wound around the coil bobbin (305);
a magnet (313) coupled to the coil bobbin (305); and
wherein the keeper plate (402) is prevented from contacting the coil bobbin (305).

2. The transducer assembly (300) of claim 1, comprising a flux ring (307) disposed to circumscribe at least a portion of the coil bobbin (305).

3. The transducer assembly (300) of claim 1, comprising a flux ring (307) disposed to circumscribe at least a portion of the coil (309).

4. The transducer assembly (300) of claim 1, wherein the magnet (313) is coupled to the coil bobbin (305) with a pole piece (311).

5. The transducer assembly (300) of claim 1, wherein the magnet (313) is a permanent magnet.

6. The transducer assembly (300) of claim 1, wherein the coil bobbin (305), the coil (309), and the magnet (313) are fixed in place with relation to each other.

7. The transducer assembly (300) of claim 1, wherein the meter electronics (20) provides an oscillating current to the coil (309) that induces motion of the keeper plate (402).

8. The transducer assembly (300) of claim 1, wherein the keeper portion (401) and the magnet portion (301) are coupled to first and second portions of the vibrating meter, respectively, wherein at least one of the first and second portions of the vibrating meter comprise a flow conduit (103A, 103B).

9. A method for forming a vibrating meter including a sensor assembly with one or more flow conduits, comprising steps of:
forming a keeper portion comprising a keeper plate;
coupling the keeper portion to a first component of the vibrating meter;
forming a magnet portion comprising a coil bobbin;
coupling the magnet portion to a second component of the vibrating meter;
winding a coil around the coil bobbin;
coupling a magnet to the coil bobbin;
placing the keeper plate proximate the magnet;
electrically coupling the coil to a meter electronics.

10. The method of claim 9, wherein the first component and second component comprise at least one flow conduit.

11. The method of claim 9, further comprising the step of circumscribe at least a portion of the coil bobbin with a flux ring.

12. The method of claim 9, further comprising the step of coupling the magnet to the coil with a pole piece.

13. The method of claim 9, further comprising the step of fixing the coil bobbin, coil, and magnet in place with relation to each other.

14. The method of claim 9, further comprising the step of providing an oscillating current to the coil that induces motion of the keeper plate.

15. The method of claim 9, further comprising the step of receiving an oscillating current from the coil, wherein the oscillating current is induced by the motion of the keeper plate.
